(19) United States
(12) Patent Application Publication
(10) Pub. No.: US 2012/0296712 A1
(43) Pub. Date: Nov. 22, 2012

(54) METHOD, SYSTEM, APPARATUS, AND MEDIA FOR IMPROVING PAID SEARCH REALIZATION

(75) Inventor: Jonathon Barnett Morris, Chicago, IL (US)

(73) Assignee: RISE INTERACTIVE, Chicago, IL (US)

(21) Appl. No.: 13/346,524

(22) Filed: Jan. 9, 2012

Related U.S. Application Data
(60) Provisional application No. 61/487,553, filed on May 18, 2011.

(51) Int. Cl. G06Q 30/02

(52) U.S. Cl. 705/14.4

(57) ABSTRACT

A method, system, apparatus and medium are directed to advertising over a network. A server receives a product feed from at least one client device. If a product in the product feed is at least one of newly available and competitively priced and not currently stored and active in a data store of the server, creating or resuming at least one keyword and an advertisement for the product; and sending the created keyword and advertisement to a search engine over an advertisement placement network protocol. If the product is determined to be discontinued or unavailable, or if it is determined that a product price is at a threshold relative to a competitor's price, pausing at least one of: the creation or sending of the keyword or advertisement; or displaying of a paid search result for the product. A savings in an advertisement fund based on the pausing is realized.

This invention claims the benefit of U.S. Appl. No. 61/487,553 filed May 18,2011.

### FIELD OF THE INVENTION

This invention relates to online search and advertising of products, and more particularly to managing one or more paid-search ad curricula.

### BACKGROUND

There are many common problems that e-commerce retailers encounter when administering paid search curricula. One problem is that the retailers might be selling the exact same product (e.g., a flat screen TV that is also available from others) at a higher price point than other companies advertising on the search engines, greatly reducing the chances of generating sales as savvy Internet users go from site to site comparison shopping prior to placing an order. Another problem is that inventory fluctuates on a daily basis, requiring a scalable solution to ensure that the advertising accurately reflects the products in stock not only to avoid paying for clicks on out-of-stock or discontinued items but also to avoid disappointing search engine users and potentially hurting the company's image and/or brand. Yet another problem is that retailers are constantly adding new products, and they need an efficient way to start promoting these products.

The present invention now provides solutions to these problems.

### SUMMARY

The invention includes embodiments directed to a method, medium, system, and apparatus for advertising over a network. The method includes receiving by a server a product feed, comprising information about products. If a product in the feed is determined to be new, at least one keyword and an advertisement for the product are created automatically, and the created keyword and advertisement are sent to a search engine over an advertisement placement network protocol. If a product in the feed is determined to be unavailable, or if it is determined that a price of a product is at a specified threshold above competitors' prices, the keyword(s) and advertisement(s) are paused so that no paid search result is displayed for the product. The pausing results in savings in advertisement costs. If a product in the feed was previously paused but is now determined to be in stock and price competitive, the keyword(s) and advertisement(s) are resumed.

The method may also include associating the product feed with at least one ad curriculum; and determining a realization for the ad curriculum based on the savings. The method may also include establishing an ad curriculum with the search engine based on the product feed; and receiving updates about competitors' prices to periodically determine whether to perform the pausing step based on the updates. The media, system and apparatus may be configured to perform the actions of the above method. A non-transitory computer-readable medium may be configured to include instructions that when executed by one or more processors, causes the processor to perform at least a portion or all of the above methods.

A non-transitory computer-readable medium may be operable on a network-connected computer comprising one or more programs for carrying out a method for advertising over the network. The medium can be distributed or located in different devices or located in a single device.

### BRIEF DESCRIPTION OF THE DRAWINGS

The nature and various advantages of the present invention will become more apparent upon consideration of the following detailed description, taken in conjunction with the accompanying drawings, in which like reference characters refer to like parts throughout, and in which:

FIG. 1 shows an example of a system configured to manage a paid-search ad curriculum.

FIG. 2 shows an example of a process configured to manage a paid-search ad curriculum.

FIG. 3 shows an example of a computing environment in which embodiments of the presently disclosed system and process may be implemented.

### DETAILED DESCRIPTION OF THE INVENTION

Paid search (also referred to as Pay-Per-Click or “PPC” advertising) can be one of the most popular methods e-commerce retailers use to promote their products and brand. In one embodiment, paid search is an auction-based platform where advertisers choose to bid on a specific word or phrase (keyword). In some embodiments, the more an advertiser is willing to pay for a keyword, the higher the advertiser will appear in the paid search listings. In some embodiments, an advertiser is charged when someone clicks on their ad to go to their website. In some embodiments, such charges may be tracked and/or electronic and software mechanisms may be used to guarantee that corresponding payments are made.

Paid search presents e-commerce retailers with unique scenarios where money is spent inefficiently. For instance, if the retailers' products are more expensive than what is offered from competitors, the customer is likely to purchase from the competition. Also, retailers often advertise on items they do not have in stock due to prior sales or delayed receipt of product shipments, as well as due to the frequency of inventory changes and time required to make a large number of changes to paid search advertisements. In addition, many e-commerce retailers are slow to begin advertising new products in their inventory, missing the opportunity to inform potential customers of their latest additions. In the first two scenarios, retailers pay for traffic (due to clicks on their ads) but receive little to no revenue as a result, while in the third scenario the retailers realize losses of potential e-commerce revenue. Without automation, making the necessary adjustments (adding or pausing thousands or tens of thousands of products' keywords and ads) may be very time- and labor-intensive. As a result of this challenge, retailers spend marketing dollars for products that aren't profitable and fail to promote products that could drive revenue.

Accordingly, embodiments of the inventive system and process ensure that clients do not advertise on products where the retailer either has a price disadvantage or does not have any inventory. The system and process allow e-commerce clients with thousands of products to be substantially more competitive when advertising on the search engines.

As used herein, the terms “client” and “client device” refer to any electronic apparatus configured for receiving control input from a user and configured to send commands or data either interactively or automatically to other devices. The client or client device can be an instance of the online user interface hosted on servers as retrieved by a user. As used herein, the term “process” or “method” refers to one or more steps performed at least by one electronic or computer based apparatus.

Embodiments of the inventive system and process allow e-commerce clients with a plurality of products to be substantially more competitive when advertising on search engines. The system and process provide the opportunity for e-commerce retailers to (automatically) maintain accurate, up-to-date paid search programs, and enable the ads remain cost-efficient at all times. The automation offered by the system and process allows retailers to focus on strategy by reducing the manpower needed for these time- and labor-intensive tasks.

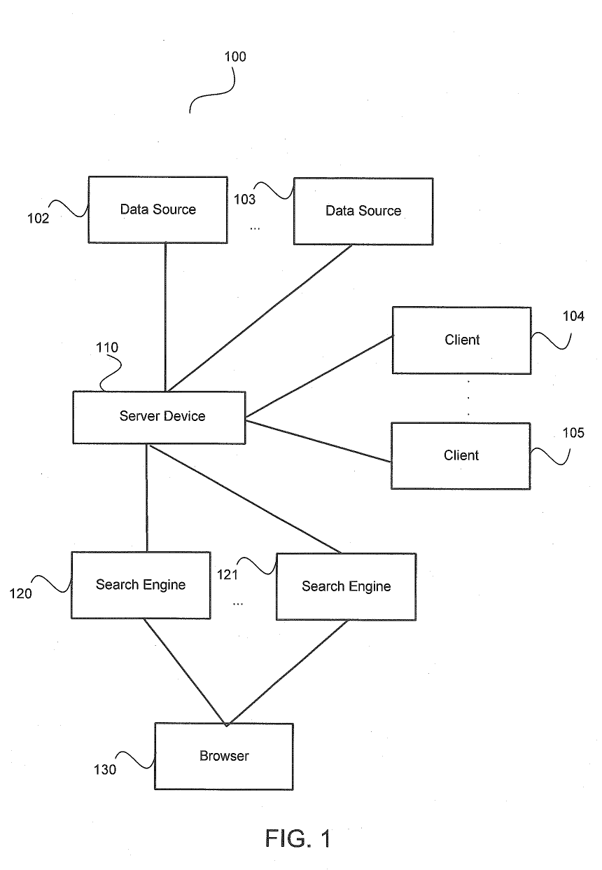

FIG. 1 shows an example system 100 for providing a competitive advertising model and process. The components of the system 100 include computer apparatuses and components. Such apparatus may include one or more processors, memories and/or network interfaces configured for communicating with other components within the system. For clarity, as used herein, the term “processor” includes one or more processors.

The system includes one or more data sources 102-103 in communication with a server 110, which is in turn in communication with clients 104-105. For clarity, as used herein, the term “server” includes one or more servers. A server can include one or more computers that manage access to a centralized resource or service in a network. A server can also include at least one program that manages resources (for example, on a multiprocessing operating system where a single computer can execute several programs at once).

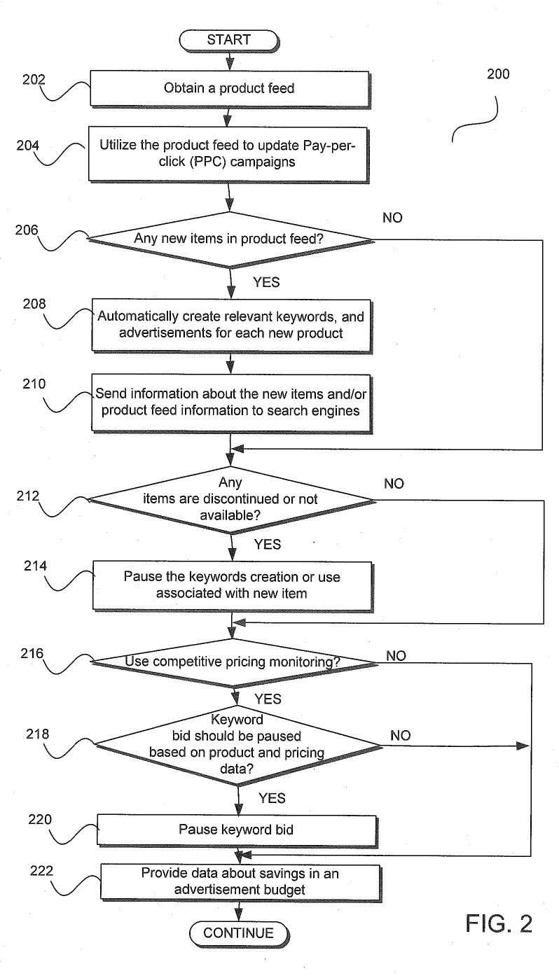

In some embodiments, the system can incorporate any number of data sources in its logical framework. While one client 104 may want to examine competitive pricing, another may want to use other information (e.g. profit margin metrics) within the logic used by the system and process. The server 110 is further in communication with search engines 120-121. Browser 130 is in communication with search engines 120-121 and configured to receive search results as described herein. System 100 is directed to executable applications or processors operative to carry out instructions for performing the process of FIG. 2, which process is further described below.

The system and process can scale the product to work more efficiently for a larger client base 104-105. In one embodiment, the system and process is modified based on client 104-105 needs, but as the number of clients 104-105 utilizing the technology increases, the system can provide a conventional, standardized process to improve scalability.

The system and process are directed to search engine flexibility. By using specifications that are compatible with the specifications for commercially available pay-per-click (PPC) advertising, cost-per-thousand (CPM) advertising, and/or site-targeted advertising, the system and process work with corresponding interfaces (i.e., APIs). The system and process are thereby configured with server 110 in communication with one or more commercially available search engines 120-121 suitable for local, national and/or international distribution. For example, in preferred embodiments, the system and process use Google AdWords USA specifications and work with Google's API. In other embodiments, the system and process can use search engines comprising Microsoft adCenter and, in the near future, Baidu, the international versions of AdWords, or any other search engines and corresponding interfaces.

FIG. 2 is a diagram of a process 200 that automates the solution described above using electronic components, such as those of FIG. 1. At step 202, in order to address the inventory issues described above, the system and process first receive a product feed from the retailer (e.g., clients 104-105). Receiving, obtaining or otherwise accessing a product feed entails leveraging a customer-provided username and password to log into a remote server via FTP (or other compatible and/or complementary protocol(s)) and retrieve a file of a specified name. E-commerce retailers use a shopping/product feed to manage the products available on their website, most often utilizing internal inventory tracking systems (e.g., data sources). In this manner, the retailers are able to accurately reflect available inventory on their websites. Product feeds usually contain information related to product specifics, including brand, model/SKU, description, product price, shipping cost and current availability.

In one embodiment, at least one of clients 104-105 receives the data feeds from one of the data sources 102-103 and/or sends the data feeds to the server 110, e.g., using appropriate interfaces made available through the server device 110 and/or search engines 120-121, such as web pages user interface, automated remote procedure calls, advertisement placement API and/or network protocol, or the like. In one embodiment, along with the product feed, the client may send configuration details for one or more ad curricula (e.g., the amount of money that should be expended—or maximum bid—per product, keyword, time, duration, geography, maximum amount for a curriculum, or the like) as part of the product feed. Flat product feeds that are pulled via FTP from advertisers, as well as existing PPC program information that is pulled from one or more advertising programs (e.g. AdWords, adCenter) via their respective APIs, provide inputs and configuration details that are entered via the user interface, The presently claimed invention determines what changes need to be made in the advertising programs and pushes these changes to the advertising programs via their respective APIs.

At step 204, the system and process utilize the product feed from the client to update automatically at least one pay-per-click (PPC) ad curriculum. In one embodiment, the server 110 associates or updates the product feed with a PPC curriculum in a database on the server 110. The PPC curriculum may be updated and/or associated with the sent ad budget. The PPC curriculum may have a combination of customizable and template features that accommodate the product feed.

At step 206, it is determined if new items are found in the product feed. In one embodiment, the product feed is stored in tangible media and/or comprises structured data, such as a file, a format (e.g., TSV, CSV, XML, etc.), and/or includes functional elements, such as database query elements. In one embodiment, the product feed is searched for items marked as new and/or compared with a previous version of the product feed to determine if there are newly available and/or competitively priced items. If so, the system and process automatically create and/or resume relevant keywords and advertisements for each new product at step 208. In one embodiment, the system and process may update the paid search curriculum using a combination of default figures (e.g., cost-per-click and ad copy) while utilizing a backend system (e.g., server 110) that may be configured to enable customizing ad copy and keywords to the specific product/item. In one embodiment, the key words and advertisements are created and based on features of the product, such as brand, model/SKU, product price, shipping cost and current availability.

At step 210, the system and process then send information about the new products/items and/or the product feed information to the search engines so that the clients can start promoting these new products/items. In one embodiment, the server device 110 sends the information to search engines 120-121.

At step 212, it is determined if items are discontinued or otherwise not available (out of stock, for instance). If so, the system and process will pause the keywords or use associated with those products to ensure the client does not spend media budgets unnecessarily at step 214. This technology solves the challenges of advertising on unavailable inventory as well as failing to advertise new products. In one embodiment, step 212-214 may be combined with step 208, and the pausing and/or filtering of these keywords can be performed on the server 110 prior to sending information to the search engines.

At step 216, in addition to automatically enabling and pausing keywords based on inventory, clients (e.g., clients 104-105) may also choose to utilize the system and process's competitive monitoring feature to address the issue of competitive pricing, e.g., using appropriate interfaces made available through the server device 110 and/or search engines 120-211. Using licensed data (e.g., from the data sources 102-103), a retailer (e.g., clients 104-105) can provide pricing information from relevant competitors. At step 218, the system and process determines based on available pricing and product data whether to pause a product (keyword)'s search result from appearing when a price is above a set threshold relative to a competitor's price (e.g., the product price exceeds a competitor's price by a preset amount). For example, a client may decide that products don't sell when the price point is 15% higher than the competition's products, using appropriate interfaces provided by server device 110 and/or search engines 120-211. In one embodiment, the server determines if the price exceeds another price (e.g., competitor's price) by a selectable percentage point. In another embodiment, the server determines if the price exceeds another price (e.g., competitor's price) by a selectable number of currency units (e.g., the competitor sells an identical product for $10 USD less than retailer). In another embodiment, the server determines if the price, relative to another price (e.g., competitor's price), is at or approaches a certain threshold (e.g., the competitor offers product incentives that effectively drop the competitor's total price below that of the retailer, the incentives including but not limited to reimbursement of delivery and other fees, buy-one-get-one-free promotions, etc.). In other embodiments, other triggers for pausing a paid search advertisement may be used based on the product, price, competitor, and other factors determined by the client. If the determination at step 218 is “yes”, at step 220, the system and process (e.g., server device 110 and/or search engines 120-211) can be configured to pause any paid search ads related with such items/products that exceed this difference in cost. If the determination at step 218 is “no”, the system and process unpause the ad and set the keyword to active. This may ensure that a paid search's media budget is spent as effectively as possible by solving the issue of competitive pricing.

In one embodiment, the system and process provide the opportunity for e-commerce retailers to maintain accurate, up-to-date paid search programs, ensuring that the clients remain cost-efficient at all times. The automation offered by the system and process also allows retailers to focus on strategy by reducing the manpower needed for these time- and labor-intensive tasks. In one embodiment, this maintenance of accurate, up-to-date paid search curricula comprises the above steps and/or includes updating a database with information, including statistics on how effective an ad curriculum was, including amount of sales per ad dollars spent, so that the client can determine whether a particular paid search curriculum was effective. In one embodiment, server device 110 and/or search engines 120-121 may calculate this information and/or may provide this information to client 104-105, through an appropriate interface.

For the sake of brevity, it should be understood that certain structures and functionality, or aspects thereof, of embodiments of the present invention that are evident from the illustrations of the Figures have not been necessarily restated herein.

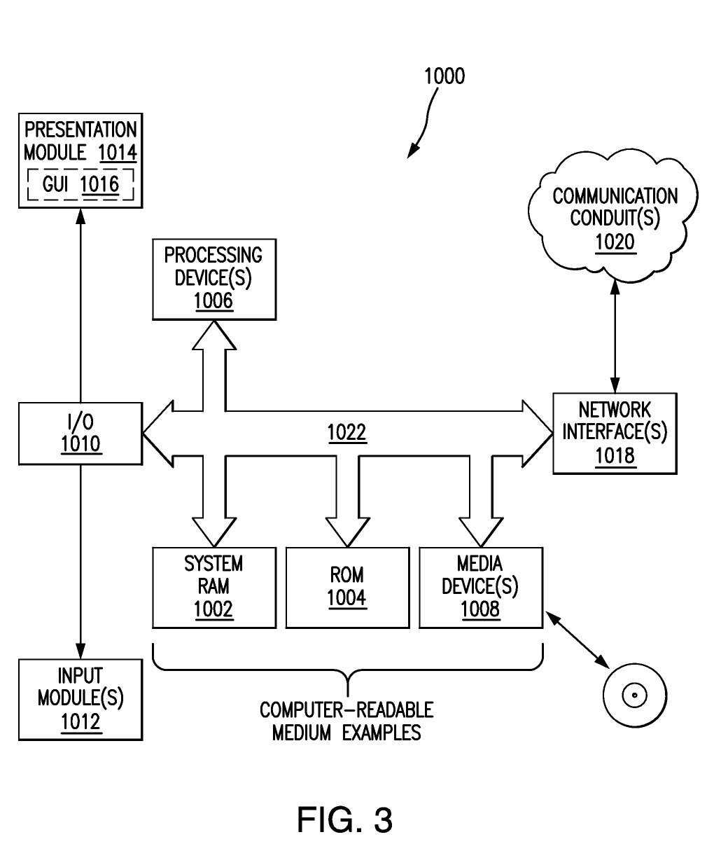

The various techniques described herein may be implemented in connection with hardware or software or, where appropriate, with a combination of both. FIG. 3 sets forth illustrative electrical data processing functionality 1000 that can be used to implement any aspect of the functions described above. In one case, the processing functionality 1000 may correspond to any type of computing device that includes one or more processing devices. The computing device can include any type of computer, computer system or other programmable electronic device, including a client computer, a server computer, a portable computer (including a laptop and a tablet), a handheld computer, a mobile phone (including a smart phone), a gaming device, an embedded controller and any combination and/or equivalent thereof (including touchless devices). Moreover, the computing device may be implemented using one or more networked computers, e.g., in a cluster or other distributed computing system. It is understood that the exemplary environment illustrated in FIG. 3 is not intended to limit the present disclosure, and that other alternative hardware and/or software environments may be used without departing from the scope of this disclosure. Further, the terms “computing device”, “computer device”, “computer” and “machine” are understood to be interchangeable terms and shall be taken to include any collection of computing devices that individually or jointly execute a set (or multiple sets) of instructions to perform any one or more of the methods discussed herein.

The processing functionality 1000 can include volatile memory (such as RAM 1002) and/or non-volatile memory (such as ROM 1004 as well as any supplemental levels of memory, including but not limited to cache memories, programmable or flash memories and read-only memories). The processing functionality can also include as one or more processing devices 1006 and optional media devices 1008 (e.g, a hard disk module, an optical disk module, etc.).

The processing functionality 1000 can perform various operations identified above with the processing device(s) 1006 executing instructions that are maintained by memory (e.g., RAM 1002, ROM 1004 or elsewhere). The disclosed method and system may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for practicing the presently disclosed method and system. When implemented on a general-purpose processor, the program code combines with the processor to provide a unique apparatus that operates to invoke the functionality of the presently disclosed method and system. Additionally, any storage techniques used in connection with the presently disclosed method and/or system may invariably be a combination of hardware and software.

The processing functionality 1000 also includes an input/output module 1010 for receiving various inputs from a user (via input modules 1012) and for providing various outputs to the user. One particular output mechanism may include a presentation module 1014 and an associated graphical user interface (GUI) 1016 incorporating one or more I/O devices (including but not limited to a display, a keyboard/keypad, a mouse and/or other pointing device, a trackball, a joystick, a haptic feedback device, a microphone, a speaker, a touch screen, a touchpad, a webcam, 2-D and 3-D cameras, and similar and complementary devices that enable operative response to user commands that are received at a computing device).

Otherwise, user input may be received via a computing device coupled to another computing device over a network. The processing functionality 1000 can also include one or more network interfaces 1018 for exchanging data with other devices via one or more communication conduits 1020. One or more communication buses 1022 communicatively couple the above-described components together. This configuration may be desirable where a computing device is implemented as a server or other form of multi-user computer, although such computing device may also be implemented as a standalone workstation, desktop, or other single-user computer in some embodiments. In such configuration, the computing device desirably includes a network interface in operative communication with at least one network. The network may be a LAN, a WAN, a wireless network, and/or the Internet, although the network is not limited to these network selections.

The computing device can operate under the control of an operating system that executes or otherwise relies upon various computer software applications. For example, a database management system (DBMS) may be resident in the memory to access a database (not shown). The database may be stored in a separate structure, such as a database server, connected, either directly or through a communication link, with the remainder of the computing device. Moreover, various applications may also execute on one or more processors in another computer coupled to the computing device via a network in a distributed or client-server computing environment.

It is to be understood that the invention is not to be limited to the exact configuration as illustrated and described herein. Accordingly, all expedient modifications readily attainable by one of ordinary skill in the art from the disclosure set forth herein, or by routine experimentation there from, are deemed to be within the spirit and scope of the invention as defined by the appended claims.

1. A computer-implemented method for advertising over a network, which comprises:
receiving by a server a product feed, comprising information about products;
determining, by a computer, if at least one product in the product feed is at least one of newly available and competitively priced; and
if a product in the feed is at least one of newly available and competitively priced:
creating or resuming at least one keyword and an advertisement for the product;
sending the created keyword and advertisement to a search engine over an advertisement placement network protocol; and
if it is determined that a price of a product is a set threshold relative to a competitor's price:
pausing the creation of sending of the keyword or advertisement; and
pausing the display of a paid search result for the product.

2. The method of claim 1, which further comprises:
if the product is determined to be discontinued or not available:
pausing at least one of:
the creation or sending of the keyword or advertisement; and
displaying of a paid search result for the product.

3. The method of claim 2, which further comprises:
associating the product feed with at least one ad curriculum; and
determining a realization in advertising costs based on savings achieved by the pausing step.

4. The method of claim 2, which further comprises:
establishing one or more ad curricula with the search engine based on the product feed; and
receiving updates about competitors' prices to periodically determine whether to perform the pausing step based on the updates.

5. The method of claim 2, which further comprises:
unpausing a previously paused keyword if the product is determined to be at least one of newly available and competitively priced.

6. A system for advertising over a network, comprising:
a server in communication with a search engine and at least one network-connected client device, the server configured to perform actions comprising:
receiving a product feed, comprising information about products;
determining if at least one product in the product feed is at least one of new and not currently stored in a data store and competitively priced;
if a product in the feed is at least one of new and competitively priced:
creating at least one keyword and an advertisement for the product; and
sending the created keyword and advertisement to the search engine over an advertisement placement network protocol; and
if it is determined that a price of the product is a threshold relative to a competitor's price:
pausing the creation or sending of the keyword or advertisement; and
pausing the display of a paid search result for the product.

7. The system of claim 6, wherein the actions to be performed further comprise:
if the product is determined to be discontinued or not available:
pausing at least one of:
the creation or sending of the keyword or advertisement; and
displaying of a paid search result for the product.

8. The system of claim 7, wherein the actions to be performed further comprise:
associating the product feed with at least one ad curriculum; and
determining a realization in advertising costs based on savings achieved by the pausing step.

9. The system of claim 7, wherein the actions to be performed further comprise:
establishing one or more ad curricula with the search engine based on the product feed; and
receiving updates about the competitor's price to periodically determine whether to perform the pausing step based on the updates.

10. The system of claim 7, wherein the actions to be performed further comprise:
unpausing a previously paused keyword if the product is determined to be at least one of newly available and competitively priced.

11. A non-transitory computer readable-medium operable on a network-connected computer comprising one or more programs for advertising over a network by performing steps that comprise:
receiving by a product feed, comprising information about products;
determining if at least one product in the product feed is at least one of newly available and competitively priced;
if a product in the feed is at least one of newly available and competitively priced:
creating or resuming at least one keyword and an advertisement for the product; and
sending the created keyword and advertisement to a search engine over a advertisement placement network protocol; and
if it is determined that a price of a product is a threshold relative to a competitor's price:
pausing the creation or sending of the keyword or advertisement; and
pausing the display of a paid search result for the product.

12. The computer-readable medium of claim 11, wherein the steps further comprise:
if the product is determined to be discontinued or not available:
pausing at least one of:
the creation or sending of the keyword or advertisement; and
displaying of a paid search result for the product.

13. The computer-readable medium of claim 12, wherein the steps further comprise:
associating the product feed with at least one ad curriculum; and
determining a realization in advertising costs based on savings achieved by the pausing step.

14. The computer-readable medium of claim 12, wherein the steps further comprise:
establishing one or more ad curricula with the search engine based on the product feed; and
receiving updates about the competitor's price to periodically determine whether to perform the pausing step based on the updates.

15. The computer-readable medium of claim 12, wherein the steps further comprise:
unpausing a previously paused keyword if the product is determined to be at least one of newly available and competitively priced.

16. An apparatus for advertising over a network, comprising:
a network interface for communicating over the network; and
a processor operable on a network-connected computer comprising one or programs to perform actions that comprise:
receiving by a product feed, comprising information about products;
determining if at least one product in the product feed is at least one of newly available and competitively priced; and
if a product in the feed is at least one of newly available and competitively priced:
creating or resuming at least one keyword and an advertisement for the product;
sending the created keyword and advertisement to a search engine over a advertisement placement network protocol; and
if it is determined that a price of a product is a threshold relative to a competitor's price:
pausing the creation or sending of the keyword or advertisement; and
pausing the display of a paid search result for the product.

17. The apparatus of claim 16, wherein the actions to be performed further comprise:
if the product is determined to be discontinued or not available:
the creation or sending of the keyword or advertisement; and
displaying of a paid search result for the product.

18. The apparatus of claim 17, wherein the actions to be performed further comprise:
associating the product feed with at least one ad curriculum; and
determining a realization in advertising costs based on savings achieved by the pausing step.

19. The apparatus of claim 17, wherein the actions to be performed further comprise:
establishing one or more ad curricula with the search engine based on the product feed; and
receiving updates about the competitor's price to periodically determine whether to perform the pausing step based on the updates.

20. The apparatus of claim 17, wherein the actions to be performed further comprise:
unpausing a previously paused keyword if the product is determined to be at least one of newly available and competitively priced.
